(19) United States
(12) Patent Application Publication
(10) Pub. No.: US 2025/0244728 A1
(43) Pub. Date: Jul. 31, 2025

(54) METHOD FOR CONTROLLING A DISTRIBUTED SYSTEM WITH AT LEAST ONE SENSOR, A CONTROL UNIT AND AN ACTUATOR

(71) Applicant: Robert Bosch GmbH, Stuttgart (DE)

(72) Inventors: Christoph Mark, Eich (DE); Kevin Schmidt, Herrenberg (DE); Laura Beermann, Waldbronn (DE); Paolo Pazzaglia, Tuebingen (DE)

(21) Appl. No.: 19/036,616

(22) Filed: Jan. 24, 2025

(30) Foreign Application Priority Data
Jan. 31, 2024 (DE) 10 2024 200 893.1

(51) Int. Cl. G05B 13/04

(52) U.S. Cl. CPC G05B 13/041; G05B 13/047

(57) ABSTRACT

A method for controlling a distributed system with at least one sensor, a control unit, and an actuator. The method includes: providing, at the actuator, multiple control inputs generated for different assumed sensor to actuator latencies; determining, by a computing unit of the actuator, an actual latency, by comparing time information of the receipt of sensor data at the actuator and time information of the sensor data; and selecting, by the computing unit of the actuator, the control input from the multiple control inputs which respective assumed latency corresponds to the actual latency or is closest to it.

### CROSS REFERENCE

The present application claims the benefit under 35 U.S.C. § 119 of German Patent Application No. DE 10 2024 200 893.1 filed Jan. 31, 2024, which is expressly incorporated herein by reference in its entirety.

### BACKGROUND INFORMATION

Controlling distributed systems with uncertain timing effects is a challenging topic. Examples of timing effects are uncertain sample times and uncertain delays. These timing effects are of special importance for distributed control loops where the control algorithm and the actual i.e. physical plant with its sensors and actuators are on different spatial locations. In particular, the chain sensor-control-actuator is the most sensitive to timing uncertainties, as it affects the freshness of the control commands to the plant, and thus also their accuracy with respect to the actual state of the plant.

The actual latency of the chain sensor-control-actuator has a stochastic nature, due to multiple effects such as:

Uncertain latencies due to, e.g., different channel load when V2V-communication is involved in cooperative driving functions as connected adaptive cruise control, group start, cooperative lane merging, management of an intersection.

Non-deterministic bus communication if distributed electrical-electronic (E/E) architectures, e.g., zone or centralized architectures, are involved in driving control functions.

Non-deterministic delays due to data processing and data transfer in sensor systems, e.g., camera systems which are used for the lateral motion control of vehicles and are the basis of several assistance function such as lane keeping.

Relational Database Service (RDS) solutions that include a flexible deployment of control functions. This results in different timing effects depending on the chosen computation node.

Uncertain timing effects if edge or cloud solutions are involved in the above examples.

Multiple possibilities exist how to incorporate known delays in control function designs. However, the problem of choosing the correct methodology without prior knowledge of the delays, and especially when delays change during runtimes, is unsolved.

There is no defined and fail-safe knowledge or prediction of the latencies within a distributed control loop, that is available at the time when the control input is calculated in the control function. The resulting latency from the sensor to the actuator can only be determined with certainty after the actuator has received the data, i.e., this knowledge is only available after the control input has been calculated.

### SUMMARY

A first aspect of the present invention relates to a method for controlling a distributed system with at least one sensor, a control unit and an actuator.

A method of an example embodiment of the present invention includes
Provide, at the actuator, multiple control inputs generated for different assumed sensor to actuator latencies,
Determine, by a computing unit of the actuator, an actual latency, by comparing time information of the receipt of sensor data at the actuator and time information of the sensor data,
Select, by the computing unit of the actuator, the control input from the multiple control inputs which respective assumed latency corresponds to the actual latency or is closest to it.

A second aspect of the present invention relates to a control system comprising at least one sensor, a control unit and an actuator and being adapted to perform the method according to the first aspect (or an embodiment thereof).

A third aspect of the present invention relates to a computer system adapted to perform the method according to the first aspect (or an embodiment thereof).

A fourth aspect of the present invention relates to a computer program adapted to perform the method according to the first aspect (or an embodiment thereof).

A fifth aspect of the present invention relates to a computer readable medium or signal storing and/or containing the computer program according to the third aspect (or an embodiment thereof).

The technique of the first to fifth aspects can have advantageous technical effects.

The techniques of the present invention may determine sensor to actuator latencies or delays especially latencies or delays which change during runtime. Further, such variable or unknown latencies from the sensor to the actuator may be corrected for thereby improving system performance and stability.

The techniques of the present invention may make use of powerful computational resources of distributed setups, e.g., edge/cloud/zone architectures, so that different control strategies can be run together. In particular, multiple control functions optimized for different sensor-to-actuator latencies may be used. Their corresponding control inputs may be sent to a smart actuator, which includes a computational or logic unit that can calculate the overall delay, for example, by checking timestamps originated from the sensor data. Then, the smart actuator may choose the correct control input associated to the delay corresponding to the real measured latency from sensor to actuator.

The techniques of the present invention may be used during the control design of various distributed systems that comprise powerful computational resources and where uncertain timing effects play a major role in the chain sensor-control-actuator.

The techniques of the present invention may be used to enhance the design of already existing control functions, when they are required to be deployed to a different distributed system, where they would experience different sensor-to-actuator latencies. The original control design may be maintained if the delay experienced in some cases resembles the original design, while additional operating modes may be added to cover additional operating modes.

The techniques of the present invention may be used for V2V-communication e.g. for cooperative driving functions as connected adaptive cruise control, group start, cooperative lane merging, management of an intersection. An example may be a connected driving function for the longitudinal motion control. Further, the techniques of the present disclosure may be used for robotics as e.g. swarm applications or floor conveyors. The techniques of the present disclosure may also be used for variable production lines with centralized wireless control. The latencies in communication can thus be compensated for at the actuator thereby enabling precise time-critical production.

### BRIEF DESCRIPTION OF THE DRAWINGS

FIG. 1 is a flow diagram illustrating a method for controlling a distributed system according to the first aspect of the present invention.

FIG. 2 shows schematically a possible topology of the present techniques, according to example embodiments of the present invention.

FIG. 3 shows schematically a possible topology of the present techniques, according to example embodiments of the present invention.

### DETAILED DESCRIPTION OF EXAMPLE EMBODIMENTS

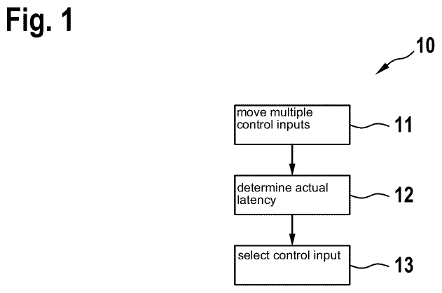

FIG. 1 shows a method for controlling a distributed system with at least one sensor, a control unit and an actuator. The distributed system may include a physical plant/process to be controlled, a sensor, a digital controller and a smart actuator (also called actuator) in the following. The smart actuator includes a computing unit e.g. as an embedded device capable of providing at least limited computational power sufficient for comparing numerical values as latency values and choosing or selecting a closest value. The controller may execute on a cloud or edge device, or on a dedicated processor with significatively larger computational power than a classic embedded device. Sensor, controller and actuator are connected via a networked communication infrastructure. The physical/technical plant/process to be controlled may be included in or excluded from the distributed system. The sensor may measure at least one property of a technical system and the actuator may actuate at least one property of the technical system.

In a first step 11, provide, at the actuator, multiple control inputs generated for different assumed sensor to actuator latencies. To provide the multiple control inputs includes to generate them e.g. at the control unit of the system and transmit them to the actuator. Further, to provide multiple control inputs includes to retrieve (or transmit) already generated control inputs from a storage which can be local e.g. at the actuator or located in the system or in a cloud.

The term sensor to actuator latency (or delay) define the timespan a signal needs to travel in the network from the sensor to the actuator. Such latency may include computational times at the control unit, the actuator and if present at the sensor. The assumed latencies may be derived from at least one of historical data, network observation, run-time estimations, and calculation delays.

The multiple control inputs may be calculated from multiple control functions wherein each of the control functions is optimized against a specific sensor to actuator latency or wherein the multiple control inputs are derived from previous calculations or from stored data. The calculation from multiple control functions may be executed by the control unit of the distributed system.

At least one of the multiple control functions may comprise a state estimation algorithm. If one or multiple control functions or controller modes require full state knowledge, a state estimation algorithm may be developed and integrated into the algorithm. This can be realized as a common controller submodule for all control modes which need this information. For example, a moving horizon estimator scheme may be applied.

In a further step 12, determine, by a computing unit of the actuator, an actual latency, by comparing time information of the receipt of sensor data at the actuator and time information of the sensor data. The time information of the sensor data may be created at the time of generation of the data or at the time of sending the data from the sensor. The time information may include an absolute time information such as a time stamp or a relative indication of time.

In a further step 13, select, by the computing unit of the actuator, the control input from the multiple control inputs which respective assumed latency corresponds to the actual latency or is closest to it. In case of a large difference between the assumed latency and the actual latency a feedback to the control unit may be implemented. Alternatively or additionally, one control input may be provided as a fallback mode. The fallback mode spans a latency from the latency of a prior control input to a very large or infinity value of the latency. Such fallback mode can also be applied to latency bands.

The sensor and the actuator may be time synchronized which allows for optimal accuracy when comparing time information. Further, the control unit, the sensor and the actuator may be time synchronized so that a latency between the sensor and the control unit may be dynamically compensated. If the controller is synchronized with the actuator/sensor device(s), a dynamic compensation of the possibly variable delay between sensor and controller is possible. In addition, estimation schemes for the computational delay may be incorporated. In this case, the control unit may label the sent input values at generation of a control input with its own time information like a timestamp. This may decrease the amount of overall delay to be dealt with the control designs significantly. Further, the performance of the closed-loop system may be increased.

The method 10 may further include the following initial steps to be carried out before the first method step 11. These steps define the generation of the multiple control inputs. For the method 10, the multiple control inputs may be precalculated and thus be available so that the following steps are optional to the method 10.

Receive, at the control unit, sensing data and time information from the sensor,

Generate, at the control unit, multiple control inputs for different assumed sensor to actuator latencies starting from the received time information from the sensor,

Transmit, to the actuator, the multiple control inputs together with the respective assumed sensor to actuator latencies.

The multiple control inputs may be generated by using a number of control functions. The number of control functions may be defined by a range of latencies to be covered. A control function or a mode is calculated for a certain latency range or band. This number of control functions may be limited to be smaller than ten.

The respective assumed sensor to actuator latencies may be integral to the multiple control inputs and may be detectable by the actuator. Also, the respective assumed sensor to actuator latencies may be provided additionally with their respective control inputs e.g. as a time stamp.

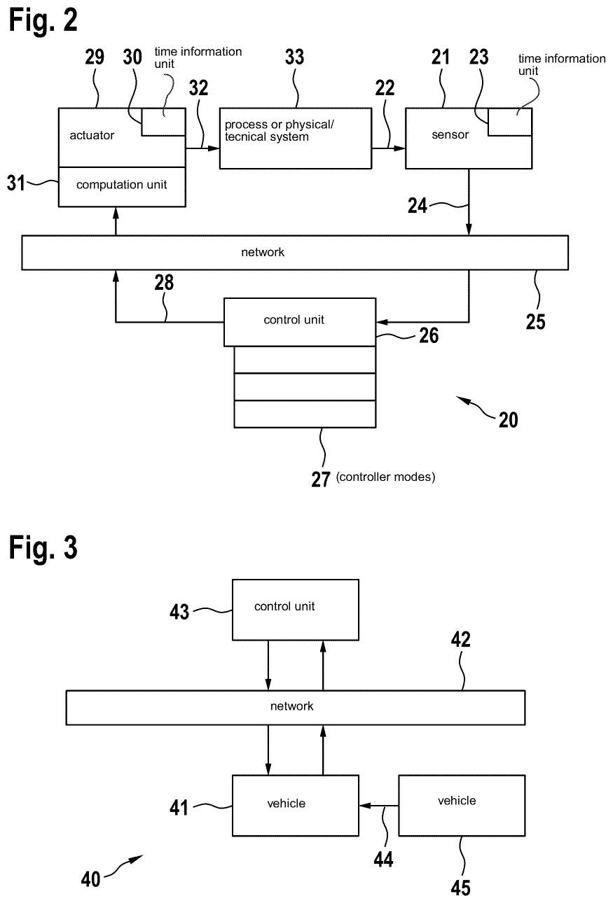

Features of the present disclosure described below in conjunction with FIG. 2 showing a control or computing system apply also to the method as described above.

FIG. 2 schematically shows a control or computing system 20 in which the techniques of the present disclosure can be used for controlling a distributed system. The computing system 20 is designed to execute the method 10 according to FIG. 1. The computing system 20 may be implemented in hardware and/or software. Accordingly, the system shown in FIG. 2 can be regarded as a computer program designed to execute the method 10 according to FIG. 1.

In the following example, the distributed system includes a sensor, a digital controller, an actuator, and optionally a physical plant/process to be controlled. The controller executes on a cloud or edge device, or on a dedicated processor with significatively larger computational power than a classic embedded device. Sensor, controller and actuator are connected via a networked communication infrastructure. The controller is implemented as a set of control functions C₁, . . . , C_{N} (called hereafter controller “modes”), each of them optimized to a specific sensor-to-actuator latency or a specific interval of sensor-to-actuator latencies.

Each of these functions is univocally labelled (e.g., with an integer number). Sensor and actuator are synchronized, i.e., they agree on a common notion of time. This can be done with any state-of-the-art mechanism (e.g., handshaking), and may be repeated regularly to avoid the effects of clock drifting. When sensor and actuator are connected to the same platform (i.e., they share the same clock) this property can be easily verified. The actuator includes (possibly limited) computational capabilities. The actuator is able to compare the current time with the timestamp of the control input to obtain the actual sensor-to-actuator latency. The actuator is also able to select one of the values from the set of control inputs that has been received from the controller. Information to which amount of delay each mode belongs is known to the actuator. The information can be exchanged a priori or sent additionally at each execution. For some control algorithms, it is necessary that the input buffers a number of past input values which where applied to the system. The selected value is applied to the physical plant until a new control update is available. The actuator also knows the number of modes and the mapping rule between the mode label and the associated delay against which the control mode is optimized.

The control system 20 shown in FIG. 2 and according to the present disclosure can be summarized with the following sequence of actions. These actions may also seen as a method for controlling a distributed system like the control system 20.

A sensor 21 obtains sensing data 22, yₖ, obtained e.g. from a process as a car environment, a plant or the like. The sensing data 22 may be generated periodically. The sensor 21 includes a time information unit 23 adapted for providing time information to the sensing data 22 e.g. at time steps marked with k, k ∈ [1, 2, 3, . . . ]. Each data yₖ is timestamped at the source, i.e. at the sensor 21 and is associated to the corresponding (absolut) time information tₖ^{s} when the sensing data 22 has been obtained.

Sensor data 24 including the sensing data 22 together with the time information tₖ^{s}, {tₖ^{s}, yₖ}, is sent via a network 25 to a control unit 26. The transmitting or sending of the sensor data 24 may be periodical. The network 25 may be a wireless network e.g. a mobile network like a 5G network, the internet, WLAN or the like, or a wired connection, e.g., CAN or the like. The control unit 26 is located at an edge, cloud, zone or the like. Thus, some sensor to controller delay or latency τ_{sc} is present.

The control unit 26 is activated either periodically or event-driven i.e., when the sensor data 24 is received. At the start of its execution, the control unit 26 fetches the latest available sensor data yₖ, stores it locally and uses it during its execution time. This means that if new sensor data 24 arrives while the control unit 26 is already executing, the control unit 26 may not update its value. This behavior can be enforced with a buffer mechanism or a local copy that is updated only at the time of execution of the control unit 26.

The control unit 26 computes or provides a set of controller modes 27, C₁, . . . , C_{N}, which are each provided for different assumed sensor to actuator latencies or latencies bands.

There are multiple ways how a set of controller modes 27, C₁, . . . , C_{N} can be synthesized. For the sake of simplicity, we limit the explanations to linear control systems with an assumed delay τ, assume full-state knowledge and provide three different ways of control designs. This means the measured output y is equal to the state x of the process model. How this can be extended is explained below.

The starting point is the delayed continuous-time model of the process shown in FIG. 2:

$${x}^{\cdot } ( t ) = \overline{A} x ( t ) + \overline{B} u ( t - τ ) , t > 0 , x ( 0 ) = {x}_{0} \qquad ( 1 )$$

$$u ( t ) = {u}_{k} for t ∈ [ {t}_{k} , {t}_{k} + h ) , {t}_{k} = kh , k = 0 , 1 , 2 , …$$

where Ā and B̅ are the continuous time matrices of the plant model, u is the control input and h is the controller period. To properly address the timing effects, the model of (1) is transferred to the discrete-time domain with extended state zₖ, shown in Equation (2). It features the continuous-time state xₖ and a couple of old input values uₖ₋₁, uₖ₋₂, . . . depending on the particular value of the maximal/actual delay τ and the sampling time h.

$$\begin{matrix}{z}_{k + 1} = A ( τ ) {z}_{k} + B ( τ ) {u}_{k} , & k = 1 , 2 , 3 …\end{matrix} \qquad ( 2 )$$

In a first example of deterministic control, based on this representation, a set of N deterministic controllers u_{i,k}=Cᵢ(xₖ)=Kᵢzₖ can be computed for multiple values of the delay τᵢ with i=1, . . . . N. Given proper weighting matrices for state and input Q, R this can be achieved by solving the following set of equations for the auxiliary variable P and the control gain Kᵢ

$$P = {A ( {τ}_{i} )}^{T} PA ( {τ}_{i} ) - ( {A ( {τ}_{i} )}^{T} PB ( {τ}_{i} ) ) {( R + {B ( {τ}_{i} )}^{T} PB ( {τ}_{i} ) )}^{- 1} ( {B ( {τ}_{i} )}^{T} PA ( {τ}_{i} ) ) + Q \qquad ( 3 )$$

$$Ki = {( R + {B ( {τ}_{i} )}^{T} PB ( {τ}_{i} ) )}^{- 1} {B ( {τ}_{i} )}^{T} PA ( {τ}_{i} )$$

In a second example of stochastic control, alternatively, each control mode Cᵢ can be designed for an interval of delay τᵢ∈Dᵢ=[τᵢ⁻, τᵢ⁺,]. By interpreting this interval as a slowly varying uncertainty, UQ methods can be used to design the controller. By using a uniform distribution of the individual intervals U[τᵢ⁻, τᵢ⁺,], an intrusive surrogate model can be computed by using the following toolchain:

$${Z}_{k + 1} = ( {A}_{P C E} + {B}_{P C E} {K}_{P C E} ) {Z}_{k} , where {K}_{P C E} = ( {K}_{i} C ⊗ {I}_{N} ) , k = 1 , 2 , 3 \qquad ( 4 )$$

$$𝔼 [ {x}_{k} ] = C M {Z}_{k} ,$$

$$𝕍 [ {x}_{k} ] = C V {Z}_{k}^{2}$$

This system representation can be exploited to compute the control gains Kᵢ.

In a third example of MJLS-based switchting control, if the range of relevant delays are assumed, e.g., to be integer multiples of the sampling time, a switching controller u_{i,k}=Cᵢ(xₖ)=Kᵢzₖ based on Markov Jump Linear systems (MJLS) can be used for the individual controller modes.

During this execution, the control unit 26 computes for each mode a corresponding control input 28, uₖ, and stores it locally in buffers, obtaining a set of control inputs 28, {u_{k,1}, . . . , U_{k,N}}. For each mode, the control input 28 is associated with a label that univocally identifies that mode (e.g., an integer number). The whole set of control inputs is also marked with an additional label that contains the timestamp tₖ^{s} of the sensor value used to compute that set of control inputs 28.

Because of the procedure above, all the control inputs 28 obtained during one execution are related to the same sensing value 22 obtained at time tₖ^{s}.

At the end of the control unit execution, the set of control inputs 28 including all the associated labels mentioned above is sent to an actuator 29 via the network 25. The set of control inputs 28 includes the time information tₖ^{s} and the output {tₖ^{s}, u_{k,1}, . . . , U_{k,N}} of the control unit 26.

The actuator 29 includes a time information unit 30 adapted for determining an actual delay t^{a}. Further, the actuator 29 includes a computation unit 31 adapted for determining the time delay or latency. The time information unit 30 may be required for computing t^{a}. The function of the time information unit 30 may be included in the computation unit 31 in hardware and/or software.

After the actuator 29 receives the set of control inputs 28, it computes the actual delay using the current time and the (sensor) timestamp from the label, i.e., τ=t^{a}−tₖ^{s}. Based on this value, the actuator 29 selects the control input 28, that is associated with the control mode designed for the time delay that is nearest to τ. Then, the actuator 29 outputs the control input 32, uₖ, to a plant, process or physical/technical system 33.

The closest time delay can be computed either as an approximation from below or from above. When using the mode with the nearest larger delay with respect to τ, the actuator 29 may wait until the actual time delay coincides with the time delay associated with the selected control mode, and then applies it to the plant or process 33.

FIG. 3 schematically shows a control system 40 in which the techniques of the present disclosure can be used for controlling a distributed system. The control system 40 is designed to execute the method 10 according to FIG. 1. The control system 40 may be implemented in hardware and/or software.

FIG. 3 schematically shows the context of controlling the (longitudinal) motion of one or more vehicles 41 over a network 42, e.g. through an edge device like a roadsite unit. The vehicle 41 like a passenger car, a commercial vehicle, an e-bike or the like communicates via the network 42 with a control unit 43. The control unit 43 may correspond to the control unit 26 of FIG. 2. Accordingly, the sensor 21 and the actuator 29 are implemented in the vehicle 41. The vehicle 41 or parts of the vehicle 41 may correspond to the process 33 of FIG. 2. In the case shown in FIG. 3, the control goal is keeping a reference distance 44 of another vehicle 45. The vehicle 45 may be leading vehicle 41 which follows vehicle 45 in an automated driving mode.

The setup shown in FIG. 3 is one possible application where the present disclosure may provide significant benefits. Without a delay-adaptive control, the closed-loop system is potentially destabilized by the network delays or may be tuned with a poor performance. This would lead to the restriction that only large distances to the surrounding vehicles will be possible. Due to the safety-critical nature of the system, collisions are likely to occur as a consequence of poor performance. If the vehicle controller is tuned to a specific amount of delay e.g. the worst case, experiencing instead a smaller amount of delay may also deteriorate the resulting performance and lead to instabilities.

Thus, the absence of knowledge of the current delay in the control algorithm traditionally hinders good performance. Especially in cases where the control algorithm resides in a zone, edge or cloud environment, the actual round-trip delay t is by-design unknown or uncertain when the control input is computed, since there is a network-link in between. In addition, the particular value of the delay is of stochastic nature and typically varying over time depending on the network congestion. Using the proposed mode-based control scheme with a certain smartness of the local actuator, this dilemma can be overcome. Multiple controller modes C₁, . . . . C_{N} can be designed for the relevant ranges of delay. Since the information of the current delay is available when the possible control signals reach the actuator, the best control signal for the current amount of delay can be picked. This decouples the tradeoff between delay-caused robustness and the required performance.

What is claimed is:

1. A method for controlling a distributed system with at least one sensor, a control unit, and an actuator, comprising the following steps:
providing, at the actuator, multiple control inputs generated for different respective assumed sensor to actuator latencies;
determining, by a computing unit of the actuator, an actual latency, by comparing time information of a receipt of sensor data at the actuator and time information of the sensor data; and
selecting, by the computing unit of the actuator, a control input from the multiple control inputs whose respective assumed latency corresponds to the actual latency or is closest to the actual latency, relative to the respective assumed latentencies of the others of the control inputs.

2. The method according to claim 1, further comprising the following initial method steps:
receiving, at the control unit, sensing data and time information from the sensor;
generating, at the control unit, the multiple control inputs for the different assumed sensor to actuator latencies starting from the received time information from the sensor; and
transmitting, to the actuator, the multiple control inputs together with the respective assumed sensor to actuator latencies.

3. The method according to claim 1, wherein the assumed latencies are derived from at least one of: historical data, network observation, run-time estimations, calculation delays.

4. The method according to claim 1, wherein the time information includes an absolute time information including a time stamp or a relative indication of time.

5. The method according to claim 1, wherein: (i) the multiple control inputs are calculated from multiple control functions wherein each of the control functions is optimized against a specific sensor to actuator latency, or (ii) the multiple control inputs are derived from previous calculations or from stored data including vectors.

6. The method according to claim 5, wherein at least one of the multiple control functions includes a state estimation algorithm.

7. The method according to claim 1, wherein the sensor and the actuator are time synchronized.

8. The method according to claim 1, wherein the control unit, the sensor, and the actuator are time synchronized, and wherein a latency between the sensor and the control unit is dynamically compensated.

9. The method according to claim 1, wherein the sensor measures at least one property of a technical system, and wherein the actuator actuates at least one property of the technical system.

10. A control system, comprising:
at least one sensor;
a control unit; and
an actuator;
wherein the control system is configured to:
provide, at the actuator, multiple control inputs generated for different assumed sensor to actuator latencies,
determine, by a computing unit of the actuator, an actual latency, by comparing time information of a receipt of sensor data at the actuator and time information of the sensor data, and
select, by the computing unit of the actuator, a control input from the multiple control inputs which respective assumed latency corresponds to the actual latency or is closest to the actual latency, relative to the respective assumed latentencies of the others of the control inputs.

11. The control system according to claim 10, further comprising a technical system which is included in a closed-loop control with the sensor, the control unit, and the actuator.

12. A computing system configured to control a distributed system with at least one sensor, a control unit, and an actuator, the computing system configured to:
provide, at the actuator, multiple control inputs generated for different assumed sensor to actuator latencies;
determine, by a computing unit of the actuator, an actual latency, by comparing time information of a receipt of sensor data at the actuator and time information of the sensor data; and
select, by the computing unit of the actuator, a control input from the multiple control inputs which respective assumed latency corresponds to the actual latency or is closest to the actual latency, relative to the respective assumed latentencies of the others of the control inputs.

13. A non-transitory computer readable medium on which is stored a computer program for controlling a distributed system with at least one sensor, a control unit, and an actuator, the computer program, when executed by a computer, causing the computer to perform the following steps:
providing, at the actuator, multiple control inputs generated for different assumed sensor to actuator latencies;
determining, by a computing unit of the actuator, an actual latency, by comparing time information of a receipt of sensor data at the actuator and time information of the sensor data; and
selecting, by the computing unit of the actuator, a control input from the multiple control inputs which respective assumed latency corresponds to the actual latency or is closest to the actual latency, relative to the respective assumed latentencies of the others of the control inputs.
